(19) United States
(12) Patent Application Publication
(10) Pub. No.: US 2007/0272832 A1
(43) Pub. Date: Nov. 29, 2007

(54) Light Detection Tube

(76) Inventors: Hideki Fujimatsu, Shizuoka (JP); Nobuharu Suzuki, Shizuoka (JP)

Correspondence Address: DRINKER BIDDLE & REATH (DC), 1500 K STREET, N.W., SUITE 1100, WASHINGTON, DC, 20005-1209, US

(21) Appl. No.: 10/560,921

(22) PCT Filed: Jun. 15, 2004
(86) PCT No.: PCT/JP04/08358

§ 371 Date: Jan. 25, 2007

(30) Foreign Application Priority Data
Jun. 17, 2003 (JP) 2003-172504

(51) Int. Cl. H01J 43/30

(52) U.S. Cl. 250/214 VT

(57) ABSTRACT

Since a peripheral part of the sapphire plate 2 is airtightly thermally crimped to an end face (window peripheral part) of a kovar metal tube 1A surrounding a light entering window via a seal ring 7 made of aluminum, a lattice defect is prevented from occurring on the sapphire plate 2 due to diffusion of impurities on the sapphire plate 2. As a result, the generation of phosphorescence or fluorescence from the sapphire plate 2 is prevented in detecting an ultraviolet ray, and dark noise is reduced.

### TECHNICAL FIELD

The present invention relates to a light detection tube in which a sapphire plate as a photoreceiving face plate is attached to a light entering window of a vacuum vessel.

### BACKGROUND ART

In the light detection tube in which the photoreceiving face plate is attached to the light entering window of the vacuum vessel, when the photoreceiving face plate is composed of the sapphire plate so as to detect an ultraviolet ray, the peripheral part of the photoreceiving face plate is usually brazed to a window peripheral part made of metal or ceramics, surrounding the light entering window of the vacuum vessel. In this case, so as to firmly braze and fix, the peripheral part of the photoreceiving face plate is previously subjected to metallizing treatment.

When the photoreceiving face plate is made of quartz and the window peripheral part surrounding the light entering window of the vacuum vessel is made of kovar metal, a technique has been conventionally known, which airtightly thermally crimps the peripheral part of the photoreceiving face plate to the window peripheral part via a seal ring made of aluminum (for example, refer to a Patent Document 1). Similarly, another technique has also been known, which airtightly thermally crimps the peripheral part of the photoreceiving face plate made of glass and the window peripheral part made of metal or ceramics via the seal ring made of aluminum (for example, refer to a Patent Document 2).

Patent Document 1: Patent Publication No. 2690658

Patent Document 2: Japanese Published Examined Patent Application No. Sho-58-38903

### DISCLOSURE OF THE INVENTION

Herein, a demand for detecting feebler ultraviolet rays with high sensitivity has increased in recent years, and in the conventional light detection tube in which the photoreceiving face plate is composed of the sapphire plate and the peripheral part is subjected to metallizing treatment, feeble phosphorescence or fluorescence is generated from the sapphire plate in detecting the ultraviolet rays. As a result, the phosphorescence or fluorescence was found to become a dark noise in detecting feebler luminescence.

Then, it is an object of the present invention to provide a light detection tube capable of preventing a situation wherein the phosphorescence or fluorescence is generated from the sapphire plate, and of reducing dark noise.

The present inventors have conducted earnest investigations into the cause of the phosphorescence or fluorescence generated from the sapphire plate in detecting the ultraviolet rays. As a result, the present inventors have found that impurities are diffused on the sapphire plate by metallizing treatment and the cause of the phosphorescence or fluorescence generated is due to a lattice defect occurring on the sapphire plate by the impurities. The present invention was accomplished based on this finding.

That is, a light detection tube according to the present invention, in which a sapphire plate, on which a photoelectric face is formed, as a photoreceiving face plate is attached to a light entering window of a vacuum vessel, wherein a peripheral part of the sapphire plate is airtightly thermally crimped to a window peripheral part made of metal or ceramics, surrounding the light entering window via a seal ring made of aluminum.

In the light detection tube according to the present invention, since the peripheral part of the sapphire plate is airtightly thermally crimped to the window peripheral part made of metal or ceramics, surrounding the light entering window via the seal ring made of aluminum, the lattice defect is prevented from occurring on the sapphire plate due to diffusion of impurities on the sapphire plate. As a result, a situation is prevented, wherein the phosphorescence or fluorescence is generated from the sapphire plate in detecting the ultraviolet rays.

In the light detection tube of the present invention, since the sapphire plate having a thickness of 0.5 mm or less is easily damaged and the sapphire plate having a thickness of 1.0 mm or more is reduced in transmissivity of an ultraviolet ray, it is preferable that the sapphire plate has the thickness of 0.5 to 1.0 mm, and more preferably about 0.7 mm.

In the light detection tube according to the present invention, since the peripheral part of the sapphire plate is airtightly thermally crimped to the window peripheral part made of metal or ceramics, surrounding the light entering window via the seal ring made of aluminum, the lattice defect is prevented from occurring on the sapphire plate due to diffusion of impurities on the sapphire plate. Therefore, according to the present invention, the situation can be prevented, wherein the phosphorescence or fluorescence is generated from the sapphire plate in detecting an ultraviolet ray, and the dark noise can be reduced.

### BRIEF DESCRIPTION OF THE DRAWINGS

FIG. 1 is a side view shown by partly breaking a light detection tube according to an embodiment;

FIG. 2 is an exploded perspective view showing a thermocompression bonding structure of a sapphire plate shown in FIG. 1;

FIG. 3 shows a schematic configuration diagram of a thermocompression bonding apparatus for obtaining the thermocompression bonding structure shown in FIG. 2; and

FIG. 4 is a partial enlarged sectional view showing a modification of the thermocompression bonding structure of the sapphire plate.

### BEST MODES FOR CARRYING OUT THE INVENTION

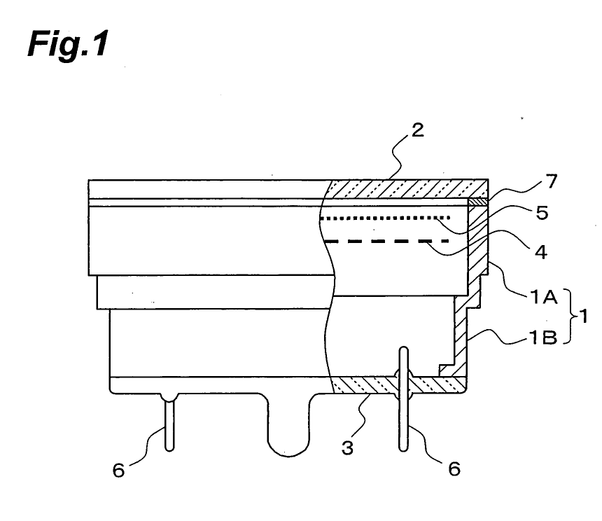

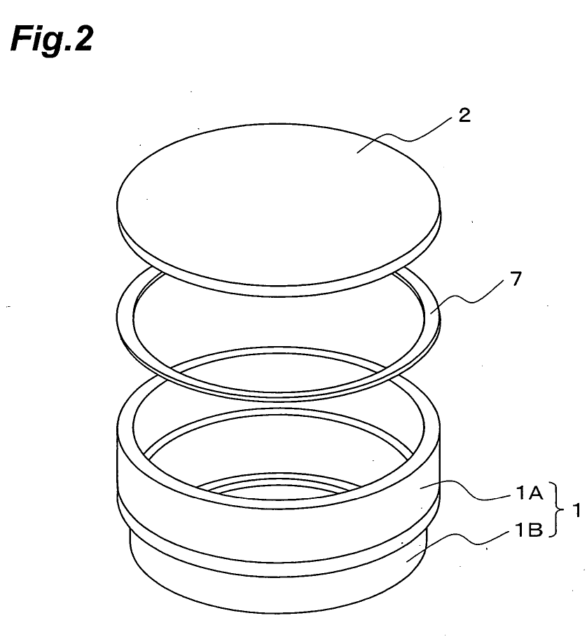

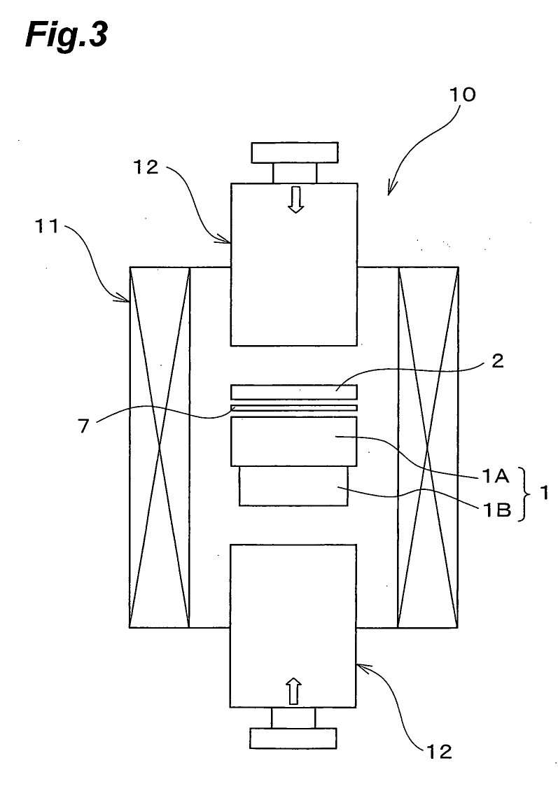

Hereinafter, an embodiment of the light detection tube according to the present invention will be described with reference to the drawings. In the referred to drawings, FIG. 1 is a side view shown by partly breaking the light detection tube according to an embodiment, and FIG. 2 is an exploded perspective view showing a thermocompression bonding structure of a sapphire plate shown in FIG. 1. FIG. 3 shows a schematic configuration diagram of a thermocompression bonding apparatus for obtaining the thermocompression bonding structure shown in FIG. 2.

As shown in FIG. 1, the light detection tube according to the embodiment is provided with a vacuum vessel having a structure where a sapphire plate 2 as a photoreceiving face plate 2 is airtightly fixed to one end opening of a cylindrical side tube 1 forming a light entering window, and a stem plate 3 is airtightly fixed to the other end opening. A reflected type dynode 4 and anode 5 are accommodated in the vacuum vessel.

The side tube 1 is integrally composed by brazing or the like a large diameter kovar metal tube 1A to which the sapphire plate 2 is fixed, and a small diameter kovar metal tube 1B to which the stem plate 3 is fixed.

The sapphire plate 2 is attached to a light entering window of the vacuum vessel as a window material having good ultraviolet ray transmitting efficiency. Since the sapphire plate 2 having a thickness of 0.5 mm or less is easily damaged, and the sapphire plate 2 having a thickness of 1.0 mm or more is reduced in transmissivity of a ultraviolet ray, the thickness of the sapphire plate 2 is set to about 0.7 mm. Incidentally, although the transmissivity of the ultraviolet ray of 270 nm is 85% in the sapphire plate 2 having the thickness of 0.7 mm, the transmissivity of the ultraviolet ray of 270 nm is reduced to 80% in the sapphire plate 2 having the thickness of 1.0 mm.

A photoelectric face for generating photoelectrons by the absorption of the ultraviolet ray is formed on the inner surface of the sapphire plate 2. Therefore, a single crystal sapphire plate suitable for the formation of the photoelectric face is used as the sapphire plate 2. The photoelectric face is composed of a semiconductor photoelectric face having an activity layer of, for example, AlGaN.

The stem plate 3 is formed of borosilicate glass, and a plurality of stem pins 6 are airtightly penetrated in the stem plate 3. Each stem pin 6 is connected to the dynode 4 and anode 5 arranged in the kovar metal tube 1A constituting the side tube 1.

Herein, as shown in FIG. 2, the sapphire plate 2 is formed in a circular shape. The peripheral part of the inner surface is airtightly thermally crimped to the window peripheral part surrounding the light entering window of the vacuum vessel, that is, to the opening side end face of the large diameter kovar metal tube 1A constituting the side tube 1 via a circular seal ring 7 made of aluminum.

The thermocompression bonding work of the sapphire plate 2 is executed by a thermocompression bonding apparatus 10 shown in FIG. 3. This thermocompression bonding apparatus 10 is provided with a pair of pressurizing mechanisms 12 and 12 pressing the sapphire plate 2 and the side tube 1 via the seal ring 7, and an electric furnace 11 surrounding the pressurizing mechanisms 12 and 12.

In the thermocompression bonding work of the sapphire plate 2 using the thermocompression bonding apparatus 10, first, the sapphire plate 2, the seal ring 7 and the side tube 1 are heated to 470° C. from a room temperature by the electric furnace 11, and are held as they are for about 25 minutes in that state. The peripheral part of the sapphire plate 2 with the seal ring 7 sandwiched is then pressurized to the end face of the opening of the large diameter kovar metal tube 1A constituting the side tube 1 with pressure of about 2 kPa, and is held as they are for about 25 minutes in that state. The peripheral part of the sapphire plate 2 is airtightly thermally crimped to the opening side end face of the kovar metal tube 1A via the seal ring 7 made of aluminum by slowly cooling to around the room temperature to release the pressurized state.

Herein, since the sapphire plate 2 is not subjected to metallizing treatment in the light detection tube of the embodiment, a lattice defect is prevented from occurring on the sapphire plate due to diffusion of impurities on the sapphire plate 2. Therefore, even when the sapphire plate 2 is irradiated with the ultraviolet ray as a light to be measured, the generation of the phosphorescence or fluorescence from the sapphire plate 2 is prevented, and the generation of the unnecessary dark noise is prevented from the photoelectric face of the rear surface of the sapphire plate 2.

The light detection tube according to the prevent invention is not limited to the embodiment. For example, the kovar metal tube 1A in which the sapphire plate 2 as the photoreceiving face plate is thermally crimped via the seal ring 7 made of aluminum can be changed into a ceramic tube.

When the kovar metal tube 1A and the ceramic tube are formed in a square cylindrical shape, the seal ring 7 is formed in a square-ring-shape, and the sapphire plate 2 is formed in a square shape.

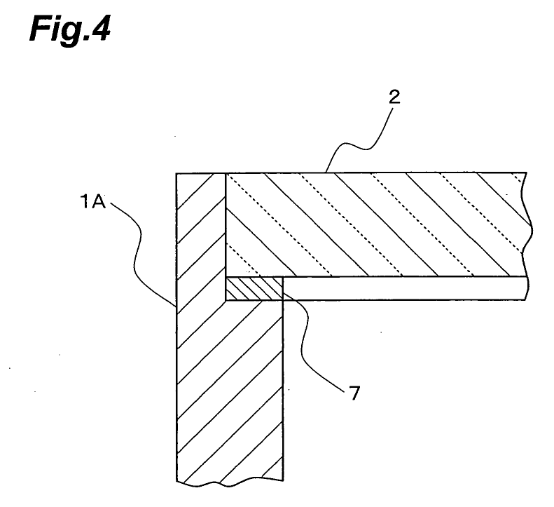

Furthermore, as shown in FIG. 4, the peripheral part of the sapphire plate 2 may be thermally crimped to the opening side end face of the kovar metal tube 1A or ceramic pipe via the seal ring 7 in a state where the peripheral part is fitted into the opening side end face by a spigot.

### INDUSTRIAL APPLICABILITY

Since the peripheral part of the sapphire plate is airtightly thermally crimped to the window peripheral part made of metal or ceramics, surrounding the light entering window via the seal ring made of aluminum in the present invention, the lattice defect is prevented from occurring on the sapphire plate due to diffusion of impurities on the sapphire plate. Therefore, the present invention can provide the light detection tube capable of preventing the situation wherein phosphorescence or fluorescence is generated from the sapphire plate in detecting the ultraviolet rays, and of reducing the dark noise.

1. A light detection tube in which a sapphire plate, on which a photoelectric face is formed, as a photoreceiving face plate is attached to a light entering window of a vacuum vessel,
wherein a peripheral part of the sapphire plate is airtightly thermally crimped to a window peripheral part made of metal or ceramics, surrounding the light entering window via a seal ring made of aluminum.

2. The light detection tube according to claim 1, wherein the sapphire plate has a thickness of 0.5 to 1.0 mm.
